(19) United States
(12) Patent Application Publication
(10) Pub. No.: US 2024/0193622 A1
(43) Pub. Date: Jun. 13, 2024

(54) INTERACTIVE USER INTERFACE (IUI) AND ASSOCIATED SYSTEMS AND METHODS FOR DISPLAY OF SUSTAINABILITY INFORMATION CORRESPONDING TO AN ITEM

(71) Applicant: AdoreMe, Inc., New York, NY (US)

(72) Inventors: Arianna LEVIN, New York, NY (US); Lea Kremski MARTENS, New York, NY (US); Christina CHANG, New York, NY (US); Ranjan ROY, New York, NY (US); Romain LIOT, New York, NY (US); Carla FIORUCCI, New York, NY (US)

(21) Appl. No.: 18/555,024

(22) PCT Filed: Apr. 19, 2022
(86) PCT No.: PCT/US2022/025341

§ 371 Date: Oct. 12, 2023

Related U.S. Application Data
(60) Provisional application No. 63/177,219, filed on Apr. 20, 2021.

(51) Int. Cl. G06Q 30/02; G06F 9/451

(52) U.S. Cl. CPC G06Q 30/02; G06F 9/451

(57) ABSTRACT

A computing entity obtains item information corresponding to an item; and processes the item information using a sustainability impact matrix defining a plurality of sustainability consideration categories and respective sub-categories. The item information is processed to determine, for each category/sub-category, whether the item satisfies one or more qualification criteria associated with the respective category/sub-category. For at least one satisfied qualification criteria, the computing entity identifies a respective graphical element from a plurality of graphical elements. A graphical element provides a summarized representation of part of the item information. The computing entity populates a data field of a data object encoding an interactive user interface (IUI) corresponding to the item with an identifier and/or locator corresponding to the respective graphical element; causes the data object to be rendered into an IUI comprising the respective graphical element; and causes the IUI to be displayed via a user computing entity.

### CROSS-REFERENCE TO RELATED APPLICATIONS

This application claims priority to U.S. Application No. 63/177,219, filed Apr. 20, 2021, the content of which is hereby incorporated by reference in its entirety.

### FIELD

Various embodiments relate generally to the field of interactive user interfaces (IUIs). For example, various embodiments relate to IUIs that provide representations of summarized and selected sustainability information corresponding to an item.

### BACKGROUND

As is generally understood, increasing sustainability is an important goal of a variety of industries. Various sustainability practices are useful for increasing sustainability of various industries. However, tracking implementation of various sustainability practices and communicating sustainability information corresponding to various items is non-trivial.

### BRIEF SUMMARY OF SOME EXAMPLE EMBODIMENTS

Various embodiments provide methods, apparatuses, computer program products, systems, and/or the like that provide and/or cause display of an IUI that includes a representation of summarized and/or selected item information corresponding to the sustainability of an item. In various embodiments, a sustainability impact matrix that defines a plurality of sustainability consideration categories (and possibly sub-categories) is used to organize item information corresponding to an item. In various embodiments, at least a portion of the item information relates to sustainability considerations and/or environmental impact of manufacturing, using, and/or maintaining the item. Each sustainability consideration category (or sub-category) is associated with one or more qualification criteria. When a portion of the item information satisfies a respective qualification criteria, a corresponding respective graphical element is identified from a plurality of graphical elements. The respective graphical element provides a graphical and/or low-word count (e.g., ten/five words or less) summary of the corresponding portion of the item information. A data object encoding an IUI corresponding to the item (e.g., providing information corresponding to the item) is updated to include an identifier configured to identify the respective graphical element and/or a locator identifying where the respective graphical element is stored in a computer-readable memory. the data object encoding the IUI corresponding to the item is rendered to generate the IUI. The IUI is then caused to be displayed via a display of a user computing entity. A user may then efficiently consume the summarized and selected sustainability information corresponding to the item via review of the respective graphical element(s) included in the IUI.

According to a first aspect a computer-implemented method for providing an IUI corresponding to an item is provided. In an example embodiment, the method comprises obtaining, by one or more processors, item information corresponding to an item; processing, by the one or more processors, the item information based at least in part on and/or using a sustainability impact matrix to determine, for each category of a plurality of sustainability consideration categories, whether the item satisfies one or more respective qualification criteria associated with the respective category. The sustainability impact matrix defines the plurality of sustainability consideration categories and respective sub-categories of respective ones of the plurality of sustainability consideration categories. The method further comprises, for at least one of the one or more respective qualification criteria that the item is determined to satisfy, identifying, by the one or more processors, a respective graphical element from a plurality of graphical elements based at least in part on the at least one of the one or more respective qualification criteria that the item is determined to satisfy. The respective graphical element provides a summarized representation of a portion of the item information that satisfies the at least one of the one or more respective qualification criteria that the item is determined to satisfy. The method further comprises populating, by the one or more processors, at least one data field of a data object encoding an IUI corresponding to the item with an identifier configured to identify the respective graphical element or locator indicating where in a memory accessible to the one or more processors the respective graphical element is stored; causing, by the one or more processors, the data object encoding the IUI corresponding to the item to be rendered such that the IUI comprises the respective graphical element; and causing, by the one or more processors, the IUI to be displayed via a display of a user computing entity.

In an example embodiment, when the IUI comprises two or more respective graphical elements, respective positioning in the IUI of the two or more respective graphical elements is determined based on respective weights associated with the respective qualification criteria corresponding to the two or more respective graphical elements.

In an example embodiment, the respective weights are dynamic weights that are determined based on at least one of (a) a class associated with the item, (b) a location of the user computing entity that is to display the IUI, (c) a user profile corresponding to a user associated with the user computing entity, or (c) a device type associated with the user computing entity.

In an example embodiment, each of the one or more respective qualification criteria and each of the plurality of graphical elements is associated with a respective category of the plurality of sustainability consideration categories, and the interactive user element comprises at most one respective graphical element for each of the plurality of sustainability consideration categories.

In an example embodiment, processing the item information based at least in part on the sustainability impact matrix to determine whether the item satisfies the one or more respective qualification criteria associated with the respective category comprises determining a category score or a sub-category score for the respective category based on the item information and the sustainability impact matrix and determining whether the category score or sub-category score satisfies a respective qualification criteria of the one or more respective qualification criteria associated with the respective category.

In an example embodiment, the item information comprises information regarding the manufacture of the item and the plurality of sustainability consideration categories comprises categories relating to different aspects of the manufacture of the item.

In an example embodiment, the different aspects are different sustainability factors.

In an example embodiment, the IUI indicates how environmentally friendly the item is via inclusion of the respective graphical element.

In an example embodiment, the item information is stored as part of an item profile corresponding to the item and is indexed by an item identifier configured to identify the item.

In an example embodiment, the item information is obtained via at least one of (a) user input via a user input device, (b) extracting the item information from one or more manufacturing aspect databases based on manufacturing information or supply information corresponding to the item based at least in part on the sustainability impact matrix.

In an example embodiment, the respective graphical element is displayed via the display of the user computing entity responsive to user interaction with an interactive toggle element of the IUI.

In an example embodiment, the IUI is (a) a webpage displayed via a browser operating on the user computing entity or (b) a page of an application operating on the user computing entity.

According to another aspect, an apparatus configured to generate, provide, and cause display of an IUI comprising one or more graphical elements is provided. In an example embodiment, the apparatus comprises one or more processors and a memory storing computer-executable instructions. The computer-executable instructions are configured to, when executed by the one or more processors, cause the apparatus to at least obtain item information corresponding to an item; and process the item information based at least in part on and/or using a sustainability impact matrix to determine, for each category of a plurality of sustainability consideration categories, whether the item satisfies one or more respective qualification criteria associated with the respective category. The sustainability impact matrix defines the plurality of sustainability consideration categories and respective sub-categories of respective ones of the plurality of sustainability consideration categories. The computer-executable instructions are further configured to, when executed by the one or more processors, cause the apparatus to at least, for at least one of the one or more respective qualification criteria that the item is determined to satisfy, identify a respective graphical element from a plurality of graphical elements based at least in part on the at least one of the one or more respective qualification criteria that the item is determined to satisfy. The respective graphical element provides a summarized representation of a portion of the item information that satisfies the at least one of the one or more respective qualification criteria that the item is determined to satisfy. The computer-executable instructions are further configured to, when executed by the one or more processors, cause the apparatus to at least populate at least one data field of a data object encoding an IUI corresponding to the item with an identifier configured to identify the respective graphical element or locator indicating where in a memory accessible to the one or more processors the respective graphical element is stored; cause the data object encoding the IUI corresponding to the item to be rendered such that the IUI comprises the respective graphical element; and cause the IUI to be displayed via a display of a user computing entity.

In an example embodiment, when the IUI comprises two or more respective graphical elements, respective positioning in the IUI of the two or more respective graphical elements is determined based on respective weights associated with the respective qualification criteria corresponding to the two or more respective graphical elements.

In an example embodiment, the respective weights are dynamic weights that are determined based on at least one of (a) a class associated with the item, (b) a location of the user computing entity that is to display the IUI, (c) a user profile corresponding to a user associated with the user computing entity, or (c) a device type associated with the user computing entity.

In an example embodiment, each of the one or more respective qualification criteria and each of the plurality of graphical elements is associated with a respective category of the plurality of sustainability consideration categories, and the interactive user element comprises at most one respective graphical element for each of the plurality of sustainability consideration categories.

In an example embodiment, processing the item information based at least in part on the sustainability impact matrix to determine whether the item satisfies the one or more respective qualification criteria associated with the respective category comprises determining a category score or a sub-category score for the respective category based on the item information and the sustainability impact matrix and determining whether the category score or sub-category score satisfies a respective qualification criteria of the one or more respective qualification criteria associated with the respective category.

In an example embodiment, the item information comprises information regarding the manufacture of the item and the plurality of sustainability consideration categories comprises categories relating to different aspects of the manufacture of the item.

In an example embodiment, the different aspects are different sustainability factors.

In an example embodiment, the IUI indicates how environmentally friendly the item is via inclusion of the respective graphical element.

In an example embodiment, the item information is stored as part of an item profile corresponding to the item and is indexed by an item identifier configured to identify the item.

In an example embodiment, the item information is obtained via at least one of (a) user input via a user input device, (b) extracting the item information from one or more manufacturing aspect databases based on manufacturing information or supply information corresponding to the item based at least in part on the sustainability impact matrix.

In an example embodiment, the respective graphical element is displayed via the display of the user computing entity responsive to user interaction with an interactive toggle element of the IUI.

In an example embodiment, the IUI is (a) a webpage displayed via a browser operating on the user computing entity or (b) a page of an application operating on the user computing entity.

According to still another aspect, a computer program product is provided. In an example embodiment, the computer program product comprises a non-transitory computer-readable medium storing computer-executable instructions. The computer-executable instructions are configured to, when executed by one or more processors of an apparatus, cause the apparatus to obtain item information corresponding to an item; and process the item information based at least in part on and/or using a sustainability impact matrix to determine, for each category of a plurality of sustainability consideration categories, whether the item satisfies one or more respective qualification criteria associated with the respective category. The sustainability impact matrix defines the plurality of sustainability consideration categories and respective sub-categories of respective ones of the plurality of sustainability consideration categories. The computer-executable instructions are further configured to, when executed by the one or more processors of the apparatus, cause the apparatus to, for at least one of the one or more respective qualification criteria that the item is determined to satisfy, identify a respective graphical element from a plurality of graphical elements based at least in part on the at least one of the one or more respective qualification criteria that the item is determined to satisfy. The respective graphical element provides a summarized representation of a portion of the item information that satisfies the at least one of the one or more respective qualification criteria that the item is determined to satisfy. The computer-executable instructions are further configured to, when executed by the one or more processors of the apparatus, cause the apparatus to populate at least one data field of a data object encoding an IUI corresponding to the item with an identifier configured to identify the respective graphical element or locator indicating where in a memory accessible to the one or more processors the respective graphical element is stored; cause the data object encoding the IUI corresponding to the item to be rendered such that the IUI comprises the respective graphical element; and cause the IUI to be displayed via a display of a user computing entity.

In an example embodiment, when the IUI comprises two or more respective graphical elements, respective positioning in the IUI of the two or more respective graphical elements is determined based on respective weights associated with the respective qualification criteria corresponding to the two or more respective graphical elements.

In an example embodiment, the respective weights are dynamic weights that are determined based on at least one of (a) a class associated with the item, (b) a location of the user computing entity that is to display the IUI, (c) a user profile corresponding to a user associated with the user computing entity, or (c) a device type associated with the user computing entity.

In an example embodiment, each of the one or more respective qualification criteria and each of the plurality of graphical elements is associated with a respective category of the plurality of sustainability consideration categories, and the interactive user element comprises at most one respective graphical element for each of the plurality of sustainability consideration categories.

In an example embodiment, processing the item information based at least in part on the sustainability impact matrix to determine whether the item satisfies the one or more respective qualification criteria associated with the respective category comprises determining a category score or a sub-category score for the respective category based on the item information and the sustainability impact matrix and determining whether the category score or sub-category score satisfies a respective qualification criteria of the one or more respective qualification criteria associated with the respective category.

In an example embodiment, the item information comprises information regarding the manufacture of the item and the plurality of sustainability consideration categories comprises categories relating to different aspects of the manufacture of the item.

In an example embodiment, the different aspects are different sustainability factors.

In an example embodiment, the IUI indicates how environmentally friendly the item is via inclusion of the respective graphical element.

In an example embodiment, the item information is stored as part of an item profile corresponding to the item and is indexed by an item identifier configured to identify the item.

In an example embodiment, the item information is obtained via at least one of (a) user input via a user input device, (b) extracting the item information from one or more manufacturing aspect databases based on manufacturing information or supply information corresponding to the item based at least in part on the sustainability impact matrix.

In an example embodiment, the respective graphical element is displayed via the display of the user computing entity responsive to user interaction with an interactive toggle element of the IUI.

In an example embodiment, the IUI is (a) a webpage displayed via a browser operating on the user computing entity or (b) a page of an application operating on the user computing entity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system that can be used to practice various embodiments;

FIG. 2 is a schematic of a system computing entity in accordance with certain embodiments;

FIG. 3 is a schematic of a user computing entity in accordance with certain embodiments;

FIG. 4 provides a flowchart illustrating various processes, procedures, and/or operations performed by a system computing entity of FIG. 2, for example, to cause an IUI comprising at least one graphical element to be displayed, in accordance with certain embodiments;

FIG. 5 illustrates at least a portion of an example sustainability impact matrix, in accordance with certain embodiments; and

FIG. 6 provides a view of an example IUI comprising at least one graphical element, in accordance with certain embodiments.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. GENERAL OVERVIEW

Various embodiments provide methods, apparatuses, computer program products, systems, and/or the like that provide and/or cause display of an IUI that includes a representation of summarized and/or selected item information corresponding to the sustainability attributes of an item.

In various embodiments, the item information comprises sustainability information that corresponds to the sustainability of a particular item. For example, the item information may comprise sustainability that corresponds to the sustainability of processes used to manufacture the item, warehouse and/or ship the item, perform maintenance of the item, use of the item, and/or disposal/recycling of the item, that are determined based on characteristics of the particular item. For example, raw materials and processes used to manufacture the item may affect the sustainability characteristics regarding manufacture of the item. In another example, the size, weight, packaging, and/or environment control needs (e.g., temperature, humidity, and/or the like) of the item may affect the sustainability characteristics regarding warehousing/transporting the item. In various embodiments, the item information may further comprise an item identifier configured to identify the corresponding item, and/or other information corresponding to the item.

In various embodiments, a sustainability impact matrix that defines a plurality of sustainability consideration categories (and possibly sub-categories) is used to organize and/or score the item information corresponding to an item. Each sustainability consideration category corresponds to a different aspect of manufacturing, warehousing and/or transporting, using, maintaining, disposing/recycling the item. In various embodiments, the different aspects of the manufacturing, warehousing and/or transporting, using, maintaining, disposing/recycling the item are sustainability factors such as raw material type, waste, water usage, chemical usage, energy usage, and/or the like. In various embodiments, at least a portion of the item information relates to sustainability considerations and/or environmental impact of manufacturing, warehousing and/or transporting, using, maintaining, disposing/recycling the item. In an example embodiment, the sustainability information of the item information corresponding to the item is organized, sectioned, and/or partitioned based on the sustainability consideration categories and/or sub-categories defined by the sustainability impact matrix. For example, item information corresponding to respective sustainability consideration categories and/or sub-categories may be identified and associated with the corresponding sustainability consideration categories and/or sub-categories. The item may then be assigned one or more scores or rankings associated with respective sustainability consideration categories and/or sub-categories.

Each sustainability consideration category (or sub-category) is associated with one or more qualification criteria. In various embodiments, determining whether item information satisfies respective ones of the one or more qualification criteria is performed based at least in part on the sustainability impact matrix. For example, based at least in part on the sustainability impact matrix and the item information, a score for the item may be determined for each of the sustainability consideration categories (and/or sub-categories thereof). It may then be determined whether the score determined for and/or assigned to the item associated with a particular sustainability consideration category or sub-category satisfies a threshold value or range for a given qualification criteria associated with the particular sustainability consideration category or sub-category to determine whether the item information satisfies the given qualification criteria.

When a portion of the item information satisfies a respective qualification criteria, a corresponding respective graphical element is identified from a plurality of graphical elements. The respective graphical element provides a graphical and/or low-word count (e.g., ten/five words or less) summary of the corresponding portion of the item information.

In various embodiments, a respective graphical element is identified for each respective qualification criteria that is satisfied by the item information. In various embodiments, at most one respective graphical element is identified and/or eventually displayed for a respective sustainability consideration category. For example, an example sustainability consideration category may be associated with a plurality of qualification criteria. These qualification criteria may be associated with sub-categories of the example sustainability consideration category or with the sustainability consideration category as a whole. In an example embodiment, when multiple qualification criteria (e.g., two or more) associated with the example sustainability consideration category or sub-categories thereof are satisfied by the item information, one of the satisfied qualification criteria is selected for identification of the corresponding respective graphical element such that only one graphical element associated with the example sustainability consideration category is displayed.

In an example embodiment, two or more respective graphical elements are identified and eventually displayed for a respective sustainability consideration category, but the two or more respective graphical elements correspond to different sub-categories of the respective sustainability consideration category. In an example embodiment, at most one respective graphical element is identified and/or eventually displayed for a respective sub-category of a respective sustainability consideration category. In an example embodiment, at most one instance of a respective graphical element is included in the resulting IUI.

In various embodiments, the one satisfied qualification criteria associated with the example sustainability consideration category or a sub-category thereof is selected based on a static or dynamic hierarchy, ranking, and/or weighting of the sub-categories of the example sustainability consideration category (or sub-categories thereof) and/or of the multiple qualification criteria associated with the example sustainability consideration category (or sub-categories thereof).

In various embodiments, the dynamic hierarchy, ranking, and/or weighting of the sub-categories of the example sustainability consideration category (or sub-categories thereof) and/or of the multiple qualification criteria associated with the example sustainability consideration category (or sub-categories thereof) is determined based on one or more of (a) a class associated with the item (e.g., is the item a clothing item, furniture item, electronic device, etc.), (b) a location of the user to which the IUI comprising the respective graphical element will be displayed (e.g., as determined based on a GPS location, IP address location, and/or the like of the corresponding user computing entity), (c) information stored in a user profile corresponding to a user associated with a computing entity that is to display the IUI comprising the respective graphical element and/or (d) a language preference associated with the computing entity that is to display the IUI comprising the respective graphical element (e.g., determined based on selected language preference, cookies, and/or the like).

A data object encoding an IUI corresponding to the item (e.g., providing information corresponding to the item) is updated to include an identifier configured to identify the respective graphical element and/or a locator identifying where the respective graphical element is stored in a computer-readable memory. The data object encoding the IUI corresponding to the item is rendered to generate the IUI.

The IUI is then caused to be displayed via a display of a user computing entity. A user may then efficiently consume the summarized and selected sustainability information corresponding to the item via review of the respective graphical element(s) included in the IUI.

In various embodiments, a respective graphical element provides a graphical and/or low-word count summary of the corresponding portion of the item information. In various embodiments, the low-word count summary comprises no more than a threshold number of words. In various embodiments, the threshold number of words (e.g., the upper bound of the number of words) permitted in the low-word count summary of the corresponding portion of the item information is language specific. In various embodiments, for English the threshold number of words permitted in the low-word count summary of the corresponding portion of the item information is ten, eight, five, or three. In an example embodiment, the number of words permitted in the low-word count summary of the corresponding portion of the item information is device specific such that the threshold number of words permitted is smaller for a device having a smaller screen (e.g., three to five words for a smartphone or other handheld device) compared to a device having a larger screen (e.g., eight to ten words for a laptop, desktop computer, or other non-handheld device).

As will be recognized by one of ordinary skill in the art, an ongoing challenge in interactive user interface design is to maximize the user experience by providing sought-after information in a consistent, logical, and low-effort fashion. Additional technical challenges for maximizing the user experience by providing sought-after information in a consistent, logical, and low-effort fashion exist for devices having smaller screens (e.g., handheld devices such as smartphones, tablets, personal digital assistants, and/or the like).

Various embodiments provide technical solutions to these challenges in the technical field of interactive user interface design. For example, in various embodiments, item information for a plurality of sustainability consideration categories is obtained for an item. The item information is then summarized and only select information is provided via the IUI. In particular, the information is organized and summarized based on a sustainability impact matrix which defines the plurality of sustainability consideration categories. Information is selected for display via the IUI based on whether respective qualification criteria are satisfied. Moreover, the information that is selected for display is represented in the IUI via one or more graphical elements that each provide respective information in an easy to digest, graphical and/or small word count format (e.g., ten/five words or less in an example embodiment). Thus, various embodiments enable an IUI to provide an improved user experience through the particular summarization, selection, and representation of information corresponding to an item as disclosed herein. The graphical element representation of the information corresponding to the item provides further technical advantages when considering IUIs configured for display by devices having smaller screens as the summarized and selected information is efficiently provided by the graphical element.

### II. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### III. EXEMPLARY SYSTEM ARCHITECTURE

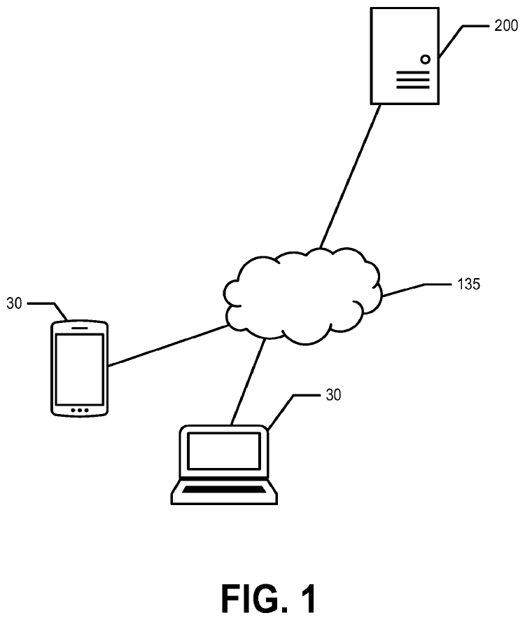

FIG. 1 provides an illustration of a system that can be used in conjunction with various embodiments of the present invention. As shown in FIG. 1, the system may comprise one or more system computing entities 200. In various embodiments, a system computing entity 200 is a server, part of a Cloud computing system (e.g., a cloud-based server), a node of a distributed network (e.g., storing a distributed ledger such as a blockchain and/or the like), and/or the like.

As shown in FIG. 1, the system may further comprise one or more user computing entities 30, one or more networks 135, and/or the like. In various embodiments, a user computing entity is a desktop computer, a client device of a system computing entity 200, a laptop, tablet, smartphone, and/or other computing device configured for user interaction therewith. In various embodiments, the network 135 comprises one or more wired and/or wireless networks configured to enable electronic communication between a plurality of computing entities. Each of the components of the system (e.g., server computing entities 200 and/or user computing entities 30) may be in electronic communication with, for example, one another over the same or different wireless or wired networks 135 including, for example, a wired or wireless Personal Area Network (PAN), Local Area Network (LAN), Metropolitan Area Network (MAN), Wide Area Network (WAN), or the like. Additionally, while FIG. 1 illustrate certain system entities as separate, standalone entities, the various embodiments are not limited to this particular architecture.

a. Exemplary System Computing Entity

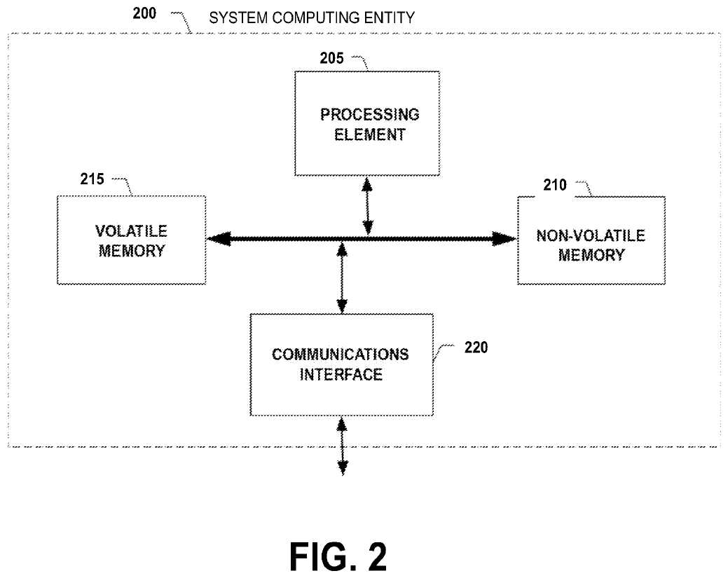

FIG. 2 provides a schematic of a system computing entity 200 according to one embodiment of the present invention. In various embodiments, a system computing entity 200 receives item information corresponding to one or more respective items. In various embodiments, the system computing entity 200 uses the item information to determine whether the item information satisfies one or more qualification criteria based at least in part on a sustainability impact matrix. In various embodiments, the system computing entity 200 is configured to generate, render, and/or provide (e.g., transmit and/or cause display of) an IUI providing a one or more respective graphical elements configured to summarize and/or represent (e.g., graphically and/or with a low-word count description) a respective qualification criteria that is satisfied by the item information.

In general, the terms computing entity, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, items/devices, vehicles, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the system computing entity 200 may also include one or more communications interfaces 220 for communicating with various computing entities, such as by communicating data, content, information, and/or similar terms used herein interchangeably that can be transmitted, received, operated on, processed, displayed, stored, and/or the like. For instance, the system computing entity 200 may communicate with other system computing entities 200, one or more user computing entities 30, and/or the like.

As shown in FIG. 2, in one embodiment, the system computing entity 200 may include or be in communication with one or more processing elements 205 (also referred to as processors, processing circuitry, and/or similar terms used herein interchangeably) that communicate with other elements within the system computing entity 200 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the system computing entity 200 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the system computing entity 200 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 205. Thus, the databases, database instances, database management system entities, data, applications, programs, program modules, scripts, source code, object code, byte code, compiled code, interpreted code, machine code, executable instructions, and/or the like may be used to control certain aspects of the operation of the system computing entity 200 with the assistance of the processing element 205 and operating system.

As indicated, in one embodiment, the system computing entity 200 may also include one or more communications interfaces 220 for communicating with various computing entities, such as by communicating data, content, information, and/or similar terms used herein interchangeably that can be transmitted, received, operated on, processed, displayed, stored, and/or the like. For instance, the system computing entity 200 may communicate with computing entities or communication interfaces of other system computing entities 200, and/or the like.

As indicated, in one embodiment, the system computing entity 200 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the node computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The system computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the system computing entity's 200 components may be located remotely from other node computing entity 200 components, such as in a distributed system. Furthermore, one or more of the components may be combined and additional components performing functions described herein may be included in the system computing entity 200. Thus, the system computing entity 200 can be adapted to accommodate a variety of needs and circumstances.

In example embodiments, the system computing entity 200 may be in communication with one or more other node computing entities 200 and/or one or more user computing entities 30. In example embodiments, the system computing entity 200 may be in communication with one or more other system computing entities 200 configured for executing, storing, managing, maintaining, and/or the like application program code corresponding to the transparent impact matrix platform, and/or the like.

b. Exemplary User Computing Entity

In an example embodiment, a user computing entity 30 may be a computing entity configured for user interaction (e.g., via a user interface thereof) for receiving, generating, and/or providing requests from a user to one or more system computing entities 200. In various embodiments, a user may be a person interacting with a user computing entity 30 (e.g., via the user interface thereof) or a machine user (e.g., an application, service, and/or the like operating on the user computing entity 30). In various embodiments, the user computing entity 30 is configured to provide (e.g., via a user interface and/or display thereof) an IUI configured to provide one or more respective graphical elements indicating respective qualification criteria that were satisfied by item information corresponding to a particular item.

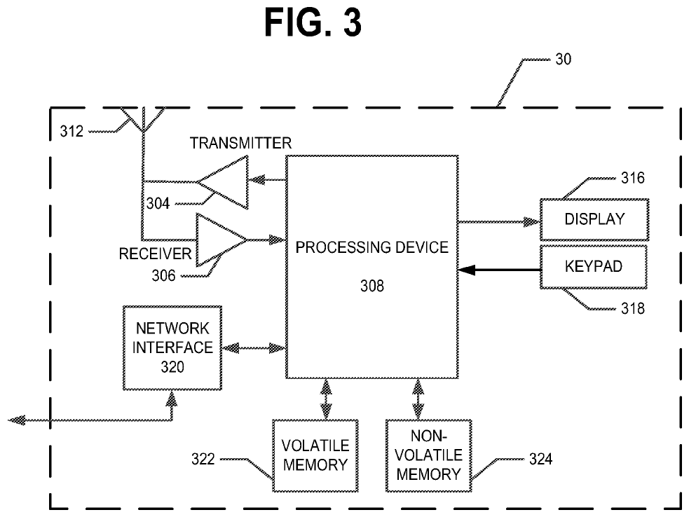

FIG. 3 provides an illustrative schematic representative of a user computing entity 30 that can be used in conjunction with embodiments of the present invention. In various embodiments, a user computing entity 30 is configured to enable user interaction with the transparent matrix impact system and/or user experience (e.g., via an IUI) of one or more measures corresponding to one or more entities, locations, and/or processes of the transparent matrix impact system. As shown in FIG. 3, a user computing entity 30 can include an antenna 312, a transmitter 304 (e.g., radio), a receiver 306 (e.g., radio), and a processing device 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as another user computing entity 30, one or more system computing entities 200, and/or the like. In this regard, the user computing entity 30 may be capable of operating with one or more air interface standards, communication protocols, modulation types, and access types. More particularly, the user computing entity 30 may operate in accordance with any of a number of wireless communication standards and protocols. In a particular embodiment, the user computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the user computing entity 30 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 30 can also download changes, add-ons, and updates, for instance, to its firmware, software (e.g., including executable instructions, applications, program modules), and operating system.

According to one embodiment, the user computing entity 30 may include location determining aspects, devices, modules, functionalities, and/or similar words used herein interchangeably. For example, the user computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the user computing entity's 30 position in connection with a variety of other systems, including cellular towers, Wi-Fi access points, and/or the like. Similarly, the user computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface (that can include a display 316 coupled to a processing device 308) and/or a user input interface (coupled to a processing device 308). For example, the user interface may be an application, browser, user interface, dashboard, webpage, and/or similar words used herein interchangeably executing on and/or accessible via the user computing entity 30 to interact with and/or cause display of information. For example, the display 316 may be configured for providing (e.g., displaying) an IUI including one or more respective graphical elements indicating respective qualification criteria that were satisfied by item information corresponding to a particular item. The user input interface can comprise any of a number of devices allowing the user computing entity 30 to receive data and/or indications of user input, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user computing entity 30 can collect contextual information/data, telemetry, information/data, and/or the like.

The user computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user computing entity 30.

In example embodiments, the user computing entity 30 may be in communication with one or more node computing entities 200 and/or one or more other user computing entities 30. In example embodiments, the user computing entity 30 may be in communication with one or more node computing entities 200 configured for executing, storing, managing, maintaining, and/or the like application program code corresponding to the transparent impact matrix platform, and/or the like.

c. Exemplary Networks

In one embodiment, any two or more of the illustrative components of the architecture of FIG. 1 may be configured to communicate with one another via respective communicative couplings to one or more networks 135. The networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for example, global networks (e.g., the Internet), metropolitan area networks (MANs), wide area networks (WANs), local area networks (LANs), or personal area networks. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### IV. EXEMPLARY SYSTEM OPERATION

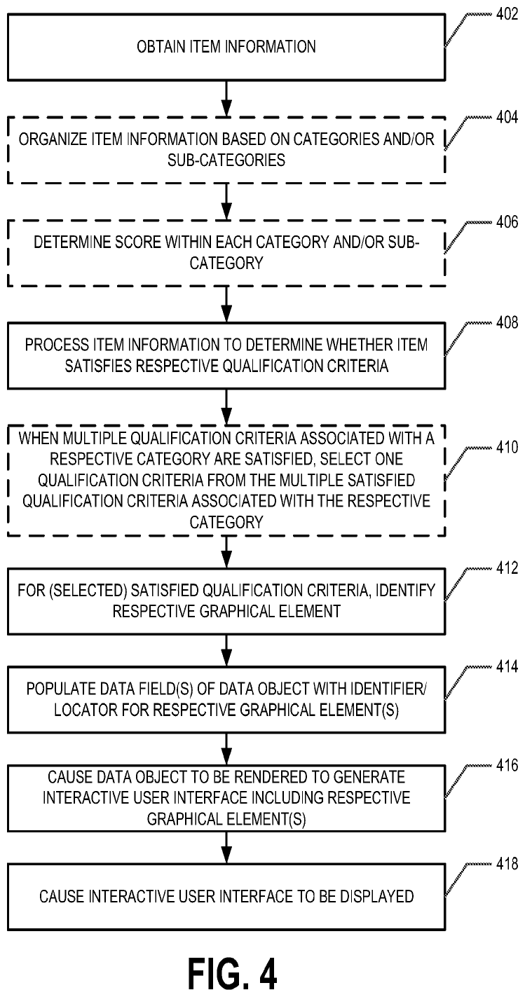

Various embodiments provide methods, apparatuses, computer program products, systems, and/or the like that provide and/or cause display of an IUI that includes a representation of summarized and/or selected item information corresponding to the sustainability attributes of an item. FIG. 4 provides a flowchart illustrating various processes, procedures, operations, and/or the like for causing the display of an IUI that includes a representation of summarized and/or selected item information corresponding to the sustainability attributes of an item.

Starting at block 402, item information is obtained. In various embodiments, the system computing entity 200 obtains item information corresponding to an item. For example, the system computing entity 200 comprises means, such as communications interface 220, processing element 205, memory 210, 215, and/or the like, for obtaining item information corresponding to an item. In various embodiments, the item information comprises sustainability information corresponding to the item. In various embodiments, the item information comprises sustainability information that corresponds to the sustainability of processes used to manufacture the item, warehouse and/or ship the item, perform maintenance of the item, use of the item, and/or disposal/recycling of the item. In various embodiments, the item information may further comprise an item identifier configured to identify the corresponding item, and/or other information corresponding to the appearance, composition, dimensions, use, and/or other aspects of the item.

In various embodiments, obtaining the item information comprises receiving at least a portion of the item information. In various embodiments, a (human) user (e.g., a member of a design team designing the item, a technician involved in manufacturing the item, and/or other human user having access to the appropriate information) interacts with a user computing entity 30 via a user interface thereof (e.g., keyboard 318, display 316) to provide user input providing at least a portion of the item information. The user computing entity 30 may then provide (e.g., transmit via network interface 320 and/or transmitter 304) at least a portion of the item information such that the system computing entity 200 receives the at least a portion of the item information.

In various embodiments, obtaining the item information comprises extracting at least a portion of the item information. In various embodiments, at least a portion of the item information is extracted from an item profile corresponding to the item. For example, the system computing entity 200 may have access to an item profile corresponding to the item. For example, the system computing entity 200 may store the item profile in memory 210, 215 or be in communication with a computing entity and/or database storing the item profile. The item profile may then be accessed (e.g., via one or more application program interface (API) calls) to extract the item information therefrom, in an example embodiment. In an example embodiment, the item profile is processed using a machine learning-trained model configured to receive the item profile as input and provide at least a portion of the item information as output.

In various embodiments, obtaining the item information comprises generating, determining and/or forming at least a portion of the item information based at least in part on received and/or extracted information corresponding to the item. In various embodiments, the sustainability information corresponding to the item is generated, determined, and/or formed by using a defined sustainability library. For example, a program, module, and/or application operating on the system computing entity may use a sustainability library (e.g., stored in memory 210, 215) to map and/or transform information corresponding to the item to sustainability information. For example, the received and/or extracted information corresponding to the item may indicate a material from which an item is made and/or one or more techniques used to make the item. For example, if the item is an article of clothing, the received and/or extracted information may include that the item is made of organic cotton that was dyed using a classic dying process. If the item is a piece of furniture, the received and/or extracted information may include that the item is made of sustainably-harvested walnut wood that was processed in Facility A. The sustainability library may then be used to determine sustainability information for the item based on an semantic understanding of “organic cotton” and the “classical dying process” or “sustainably-harvested walnut wood” and “Facility A.” For example, the sustainability library may know that Facility A is powered via solar power and has particular waste product, chemical usage, and green house gas emission profiles. In an example embodiment, based on the semantic meaning provided to the received and/or extracted information about the item, the sustainability information of the item information may be generated, determined, formed and/or the like. In an example embodiment, the sustainability library is a sustainability impact matrix.

In an example embodiment, obtaining the item information comprises accessing the item information from memory 210, 215.

At step/operation 404, the item information is organized, sectioned, and/or partitioned based on sustainability consideration categories and/or sub-categories defined by a sustainability impact matrix. For example, the system computing entity 200 organizes, sections, and/or partitions the item information based on sustainability consideration categories and/or sub-categories defined by a sustainability impact matrix. For example, the system computing entity 200 comprises means, such as processing element 205, memory 210, 215, and/or the like, for organizing, sectioning, and/or partitioning the item information based on sustainability consideration categories and/or sub-categories defined by a sustainability impact matrix.

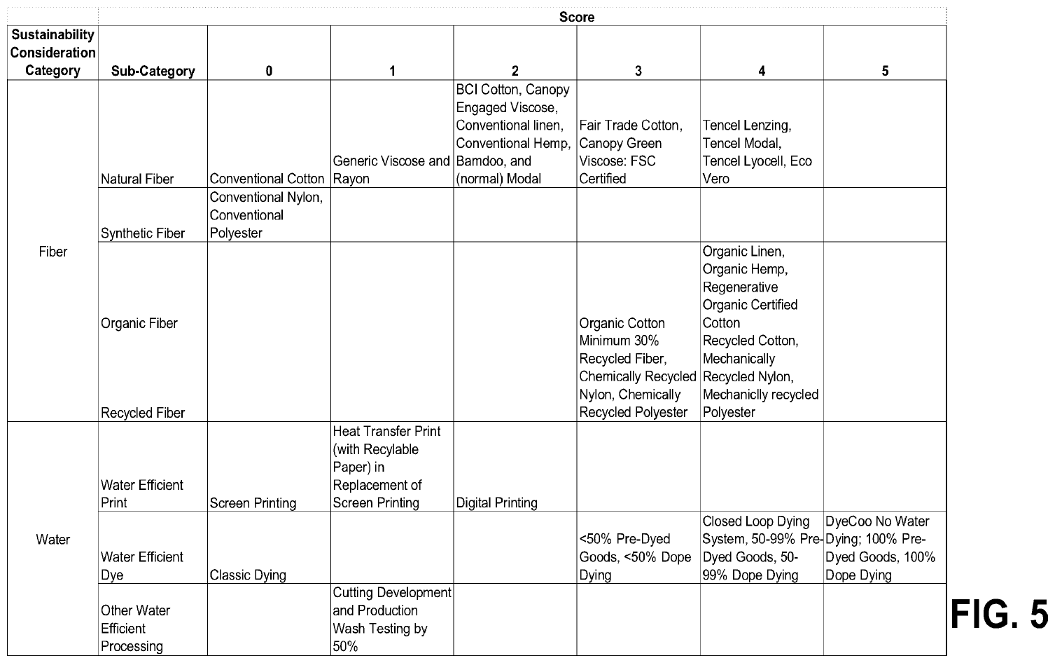

FIG. 5 provides at least a portion of an example sustainability impact matrix corresponding to the manufacture of articles of clothing. For example, the illustrated portion of the sustainability matrix corresponds to the sustainability consideration categories of Fiber (e.g., the type of fiber from which an article of clothing is made) and Water (e.g., the water usage during the manufacturing process of the article of clothing). In the example sustainability impact matrix, the sustainability consideration category Fiber comprises the sub-categories Natural Fiber, Synthetic Fiber, Organic Fiber, and Recycled Fiber. In the example sustainability impact matrix, the sustainability consideration category Water comprises the sub-categories Water Efficient Print, Water Efficient Dye, and Other Water Efficient Processing. Fiber content information of the item information and item information that may be used to identify water usage during manufacturing for the item (in an example where the item is an article of clothing) may then be organized, sectioned, and/or partitioned in accordance with the example sustainability impact matrix.

In various embodiments, the sustainability impact matrix defines a plurality of sustainability consideration categories. One or more of the plurality of sustainability consideration categories may comprise respective sub-categories. In an example embodiment, the sustainability impact matrix corresponds to the manufacture of articles of clothing and defines the sustainability consideration categories Fiber (containing Natural Fiber, Synthetic Fiber, Organic Fiber, and Recycled Fiber sub-categories), Water (containing Water Efficient Print, Water Efficient Dye, and Other Water Efficient Processing sub-categories), Waste (containing Reduce Fiber Waste, Reuse Existing Fiber, and Optimize Production Practice to Avoid Creatin of Waste sub-categories), and Chemicals (containing Optimized Printing, Optimized Dying, Oeko Tex-certified, and Other Chemical Reduction Processing sub-categories). As should be understood based on the disclosure provided hereby, various other sustainability impact matrices may be defined that each define a plurality of sustainability consideration categories (and corresponding sub-categories) that relate to different types of items (articles of clothing, furniture, electronic devices, household goods, office supplies, automobiles and/or components thereof, and/or the like) and/or different aspects of items (e.g., manufacture, warehousing and/or transportation, use, maintenance, disposal/recycling, and/or the like), as appropriate for the particular type or class of item.

Continuing with FIG. 4, at step/operation 406, a score for the item is determined for each category and/or sub-category. For example, the system computing entity 200 determines and/or assigns a score for the item for each category and/or sub-category. For example, the system computing entity 200 comprises means, such as processing element 205, memory 210, 215, and/or the like for determining and/or assigning a score for the item for each category and/or sub-category.

In various embodiments, the scores and/or rankings are determined and/or assigned for the item based at least in part on the sustainability impact matrix. For example, in an example embodiment, using the example item from above of that is an article of clothing made of organic cotton and the example portion of a sustainability impact matrix shown in FIG. 5, the item is assigned a score of 3 for the sub-category Natural Fiber and a score of 3 for the sub-category Organic Fiber. In the illustrated embodiment, scores and/or rankings are determined and/or assigned on a scale of 0 to 5. However, in various other embodiments, various other scoring scales may be used.

Continuing with FIG. 4, at step/operation 408, the item information is processed, based at least in part on the sustainability impact matrix, to determine whether the item information corresponding to the item satisfies one or more qualification criteria. For example, the system computing entity 200 processes the item information to determine whether the item information satisfies one or more qualification criteria. For example, the system computing entity 200 comprises means, such as processing element 205, memory 210, 215, and/or the like for processing the item information to determine whether the item information satisfies one or more qualification criteria.

In various embodiments, a plurality of qualification criteria are defined with each qualification criteria of the plurality of qualification criteria associated with a respective sustainability consideration category and/or sub-category. In an example embodiment, a respective qualification criteria associated with a respective sustainability consideration category and/or sub-category is determined to be satisfied when the item information organized, sectioned, partitioned, and/or determined to be associated with the respective sustainability consideration category and/or sub-category includes one or more first terms (e.g., words or phrases) and/or does not include one or more second terms (e.g., words or phrases). In an example embodiment, a respective qualification criteria associated with a respective sustainability consideration category and/or sub-category is determined to be satisfied when the score determined for and/or assigned to the item for the respective sustainability consideration category and/or sub-category satisfies a threshold value and/or range requirement. For example, a first qualification criteria associated with the sub-category Natural Fiber of the sustainability consideration category Fiber for the example sustainability impact matrix illustrated in part in FIG. 5 is satisfied when the score determined for and/or assigned to the item is at least three (e.g., three or greater). For example, a second qualification criteria associated with the sub-category Organic Fiber of the sustainability consideration category Fiber for the example sustainability impact matrix illustrated in part in FIG. 5 is satisfied when the score determined for and/or assigned to the item is three or four (e.g., in the (inclusive) range of three to four).

In various embodiments, the resulting IUI includes at most one graphical element corresponding to each sustainability consideration category. However, as should be understood, it may be possible for item information corresponding to an item to satisfy multiple (e.g., two or more) qualification criteria that are associated with the same sustainability consideration category and/or various sub-categories of the same sustainability consideration category. Thus, in various embodiments, as shown at step/operation 410 of FIG. 4, when multiple (e.g., two or more) qualification criteria associated with the same sustainability consideration category are satisfied by the item information, one satisfied qualification criteria is selected from the multiple satisfied qualification criteria associated with the same sustainability consideration category. For example, the system computing entity 200 selects one satisfied qualification criteria from the multiple satisfied qualification criteria associated with the same sustainability consideration category. For example, the system computing entity 200 comprises means, such as processing element 205, memory 210, 215, and/or the like, for selecting one satisfied qualification criteria from the multiple satisfied qualification criteria associated with the same sustainability consideration category.

For example, continuing with the example item of the article of clothing made of organic cotton from above, the item information for the item satisfies both the first qualification criteria (e.g., Natural Fiber sub-category score of three or greater) and the second qualification criteria (e.g., Organic Fiber sub-category score of three or four). Both the first qualification criteria and the second qualification criteria are associated with the sub-categories of the sustainability consideration category Fiber. Thus, in an example embodiment, only one of the first qualification criteria and the second qualification criteria is selected for continued processing (e.g., for identification of a corresponding respective graphical element and the inclusion of the respective graphical element in the IUI rendered and caused to be displayed).

In an example embodiment, two or more respective graphical elements are identified and eventually displayed for a respective sustainability consideration category, but the two or more respective graphical elements correspond to different sub-categories of the respective sustainability consideration category. In an example embodiment, at most one respective graphical element is identified and/or included in the IUI for a respective sub-category of a respective sustainability consideration category. In an example embodiment, at most one instance of a respective graphical element is included in the resulting IUI (e.g., the IUI does not include duplicate instances of the same respective graphical element).

In various embodiments, the one satisfied qualification criteria associated with the example sustainability consideration category or a sub-category thereof is selected based on a static or dynamic hierarchy, ranking, and/or weighting of the sub-categories of the example sustainability consideration category and/or of the multiple qualification criteria associated with the example sustainability consideration category (or sub-categories thereof).

In an example embodiment, the one satisfied qualification criteria associated with the example sustainability consideration category (or a sub-category thereof) is selected based on which sub-category of the example sustainability consideration category was determined to have and/or assigned the highest score. For example, if sub-category A was assigned a score of 4 and sub-category B was assigned a score of 3 (with the scaling of the score being such that a higher score indicates a preferred sustainability attribute) and both sub-categories A and B satisfied respective qualification criteria, the qualification criteria corresponding to sub-category A is selected as sub-category A is assigned a higher score than sub-category B.

In various embodiments, the dynamic hierarchy, ranking, and/or weighting of the sub-categories of the example sustainability consideration category (or sub-categories thereof) and/or of the multiple qualification criteria associated with the example sustainability consideration category (or sub-categories thereof) is determined based on one or more of (a) a class associated with the item (e.g., is the item a clothing item, furniture item, electronic device, etc.), (b) a location of the user to which the IUI comprising the respective graphical element will be displayed (e.g., as determined based on a GPS location, IP address location, and/or the like of the corresponding user computing entity), (c) information stored in a user profile corresponding to a user associated with a computing entity that is to display the IUI comprising the respective graphical element, and/or (d) a language preference associated with the computing entity that is to display the IUI comprising the respective graphical element.

In an example embodiment where a static hierarchy, ranking, and/or weighting of sub-categories and/or qualification criteria are used to select at most one satisfied qualification criteria for an item, the IUI may be fully rendered prior to receiving a request from a user computing entity 30 for the IUI. For example, a rendered version of the IUI may be stored in memory 210, 215 and provided in response to a request from a client device, program, application, and/or the like.

In an example embodiment where a dynamic hierarchy, ranking, and/or weighting of the sub-categories and/or qualification criteria are used to select at most one satisfied qualification criteria for an item (e.g., for a particular sustainability consideration category and/or sub-category thereof), the data object encoding the IUI may include identifiers and/or locators for respective graphical elements corresponding to the multiple satisfied qualification criteria associated with the same sustainability consideration category. For example, when a request for the IUI is received (e.g., by the system computing entity 200) the request may include information corresponding to the requesting user computing entity 30 and/or the user operating the requesting user computing entity 30. For example, a location of the user computing entity 30 may be provided by the request or information from which the location of the user computing entity 30 may be provided by the request. For example, the request may include a location (e.g., country, state, country, city, and/or the like) of the user computing entity 30 (e.g., determined by a location determining aspect (e.g., GPS receiver) of the user computing entity 30). For example, the request may include an IP address of the user computing entity 30 from which a location (e.g., country, state, country, city, and/or the like) of the user computing entity 30 may be determined. In another example, a received request may comprise and/or be associated with demographic information for a user of the user computing entity 30 and/or a user profile corresponding to the user of the user computing entity 30. For example, a user profile corresponding to the user and storing information regarding the user's preferences, interests, and/or the like may be stored in a user profile database stored in memory 210, 215 and/or otherwise accessible to the system computing entity 200. In various embodiments where a dynamic hierarchy, ranking and/or weighting of the sub-categories and/or qualification criteria is enabled for selection of at most one satisfied qualification item for an item (e.g., for a particular sustainability consideration category and/or sub-category thereof), a default hierarchy, ranking, and/or weighting may be used in instances where user personalization information is not provided and/or is not available.

In various embodiments, the dynamic hierarchy, ranking, and/or weighting of the sub-categories and/or qualification criteria is determined based at least in part on information that is received as part of and/or determined based on the received request for the IUI. In such embodiments, the IUI may be rendered from the data object encoding the IUI based on the dynamic hierarchy, ranking, and/or weighting after and/or responsive to receiving and/or processing the request for the IUI. For example, the data object may include identifiers and/or locaters for multiple respective graphical elements corresponding to multiple satisfied qualification criteria associated with the same sustainability consideration criteria. Based on the dynamic hierarchy, ranking, and/or weighting determined at least in part based on information received as part of and/or associated with the request for the IUI, only one respective graphical element is selected from the multiple respective graphical elements corresponding to multiple satisfied qualification criteria associated with the same sustainability consideration criteria during the rendering process. Thus, the rendered IUI includes at most one graphical element corresponding to each sustainability consideration category. In an example embodiment, the rendered IUI includes at most one graphical element corresponding to each sub-category of the sustainability consideration categories.

At step/operation 412, a respective graphical element is identified for each of the (selected) satisfied qualification criteria. For example, the system computing entity 200 identifies a respective graphical element for each of the (selected) satisfied qualification criteria. For example, the system computing entity 200 comprises means, such as processing element 205, memory 210, 215, and/or the like, for identifying a respective graphical element for each of the (selected) satisfied qualification criteria.

In various embodiments, the system computing entity 200 stores a plurality of graphical elements. For example, the system computing entity 200 may store a database comprising a plurality of graphical elements. Each graphical element is associated with a graphical element identifier configured to (uniquely) identify the respective graphical element, a locator that indicates where (e.g., in memory 210, 215) the respective graphical element is stored, one or more criteria identifiers each configured to identify a respective qualification criteria corresponding to the respective graphical element, a screen type for which the respective graphical element is configured to be displayed on (e.g., smaller screen (e.g., for a handheld device), larger screen (e.g., a non-handheld device), or both smaller screens and larger screens).

In various embodiments, a graphical element provides a representation of the corresponding qualification criteria. In various embodiments, a respective graphical element provides a graphical and/or low-word count summary of the portion of the item information that satisfied the corresponding qualification criteria. In various embodiments, the upper bound of the number of words permitted in the low-word count summary of the portion of the item information that satisfied the corresponding qualification criteria is language specific. In various embodiments, for English the upper bound on the number of words permitted in the low-word count summary of the portion of the item information that satisfied the corresponding qualification criteria is ten, eight, five, or three words. In an example embodiment, the number of words permitted in the low-word count summary of the portion of the item information that satisfied the corresponding qualification criteria is device specific such that the upper bound of the number of words permitted is smaller for a device having a smaller screen (e.g., three to five words when the requesting user computing entity 30 is a handheld device such as a smartphone, tablet, PDA, and/or the like) compared to a device having a larger screen (e.g., eight to ten words when the requesting user computing entity 30 is not a handheld device (e.g., a laptop, desktop computer, and/or the like)).

In various embodiments, the plurality of graphical elements are each stored as rendered image files such as JPEG, PNG, GIF, and/or TIFF files, for example. In an example embodiment, the rendered image files are configured to minimize storage space required for the storage thereof and/or bandwidth required for transmission thereof.

In various embodiments, a respective graphical element that corresponds to a (selected) satisfied qualification criteria is selected from the plurality of graphical elements based on one or more of a look-up table, querying the plurality of graphical elements using the criteria identifier configured to identify the (selected) satisfied qualification criteria, based on meta-data associated with the (selected) satisfied qualification criteria including an identifier configured to identify the respective graphical element, and/or the like.

At step 414, one or more data fields of a data object encoding the IUI are populated with the identifier(s) configured to identify the identified respective graphical element(s) and/or the locator(s) configured to identify the location(s) where the identified respective graphical element(s) is/are stored (e.g., in memory 210, 215). For example, the system computing device 200 populates (e.g., automatically and/or without requiring user interaction) one or more data fields of a data object encoding the IUI with the identifier(s) configured to identify the identified respective graphical element(s) and/or the locator(s) configured to identify the location(s) where the identified respective graphical element(s) is/are stored (e.g., in memory 210, 215). For example, the system computing device 200 comprises means, such as processing element 205, memory 210, 215, and/or the like for populating one or more data fields of a data object encoding the IUI with the identifier(s) configured to identify the identified respective graphical element(s) and/or the locator(s) configured to identify the location(s) where the identified respective graphical element(s) is/are stored (e.g., in memory 210, 215).

For example, identifying a respective graphical element comprises determining and/or identifying the identifier configured to identify the respective graphical element and/or determining and/or identifying the locator configured to identify the location where the identified respective graphical element is stored (e.g., in memory 210, 215). The identifier and/or locator may then be inserted into appropriate data fields of the data object. In an example embodiment, the identifier and/or locator is concatenated with an array of identifiers and/or locators already present in the data object.

At step/operation 416, the data object is rendered to generate the IUI comprising one or more graphical elements (e.g., each corresponding to a different sustainability consideration category and/or sub-category). For example, the system computing entity 200 causes the data object to be rendered such that the IUI comprising the one or more graphical elements is generated. For example, the system computing entity 200 comprises means, such as processing element 205, memory 210, 215, communications interface 220, and/or the like (e.g., one or more graphics processing units (GPUs)) for rendering and/or causing the rendering of the data object to generate the IUI comprising the one or more graphical elements.

In various embodiments, the data object contains the identifier and/or locator of at most one respective graphical element for each respective sustainability consideration category. As a result, the rendered IUI comprises at most one respective graphical element for each respective sustainability consideration category.

In an example embodiment, the data object contains the identifier and/or locator of at most one respective graphical element for each respective sub-category of each respective sustainability consideration category. As a result, the rendered IUI comprises at most one respective graphical element for each respective sub-category of a respective sustainability consideration category.

In various embodiments, the data object is configured to contain identifiers and/or locators for more than one respective graphical elements associated with a respective sustainability consideration category. During the rendering process, one of the more than one respective graphical elements associated with the respective sustainability consideration category is selected for inclusion in the rendered IUI. For example, a request for an IUI is received. The request was generated and provided (e.g., transmitted) by a user computing entity 30. A dynamic hierarchy, ranking, and/or weighting of the sub-categories and/or qualification criteria is evaluated based at least in part on information received as part of and/or associated with the request for the IUI and/or the user computing entity 30. The dynamic hierarchy, ranking, and/or weighting is then used to select one of the more than one respective graphical elements associated with the respective sustainability consideration category for inclusion in the rendered IUI. The IUI is then rendered to include the selected one respective graphical element associated with the respective sustainability consideration category. For example, the rendering of the data object to generate the IUI may include compiling the data object with a compiler configured to select one respective graphical element from the more than one respective graphical elements associated with the respective sustainability consideration category included in the data object such that the rendered IUI only includes the selected one respective graphical element and not the other graphical elements of the more than one respective graphical elements associated with the respective sustainability consideration category included in the data object.

In an example embodiment, a device type and/or screen size of the user computing entity 30 is indicated by the request for the IUI and/or associated with the requesting user computing entity 30. The device type and/or screen size of the user computing entity 30 may be used to select the respective graphical elements that are included in the rendered IUI. For example, when the device type indicates that the device is a handheld device and/or has a smaller screen (e.g., a smartphone, tablet, PDA, and/or the like) only graphical elements associated with a screen type indicating the respective graphical element is configured for display on smaller screens and/or both smaller and larger screens are included in the rendered IUI. For example, when the device type indicates that the device is not a handheld device and/or has a larger screen (e.g., a laptop, desktop computer, and/or the like) graphical elements associated with a screen type indicating the respective graphical element is configured for display on larger screen and/or both smaller and larger screens are included in the rendered IUI.

In an example embodiment, the information regarding the user computing entity 30 received as part of the request for the IUI and/or associated with the user computing entity 30 is used to determine where on the IUI the one or more respective graphical elements are positioned and/or an order in which the one or more respective graphical elements are positioned and/or placed. For example, the ordering of the respective graphical elements and/or the positioning and/or placement of the respective graphical elements on the IUI are determined based on user preferences and/or user interests as determined based on demographic information corresponding to the user and/or a user profile corresponding to the user, in an example embodiment. For example, the ordering of the respective graphical elements and/or the positioning and/or placement of the respective graphical elements on the IUI are determined based user preferences and/or user interests as determined based on a device type (e.g., handheld device (e.g., having a smaller screen) or non-handheld device (e.g., having a larger screen)). For example, the ordering of graphical elements and/or the positioning and/or placement of the graphical elements on the IUI may be personalized for the user and/or device type/screen size in order to optimize user experience of the IUI. For example, information that the user is expected to deem more important and/or to be more interested in is placed in a position of more prominence (for the display 316 of the user computing entity 30) through the dynamic ordering of the graphical elements and/or dynamic positioning and/or placement of the graphical elements in the IUI.

At step/operation 418, the IUI is displayed via the display 316 of the requesting user computing entity 30. For example, the system computing entity 200 receives a request for the IUI that was generated by a requesting user computing entity 30. The system computing entity 200 provides (e.g., transmits) the IUI. The user computing entity 30 receives the IUI. Responsive to receiving and/or processing the IUI, the user computing entity 30 is caused to display the IUI via a graphical user interface of the display 316.

In various embodiments, the system computing entity 200 causes the IUI to be displayed via the graphical user interface of the display 316 of the user computing entity 30. For example, the system computing entity 200 comprises means for causing the IUI to be displayed by a graphical user interface via the display 316 of the user computing entity 30.

In an example embodiment, the rendered IUI is pre-generated and stored (e.g., in memory 210, 215). In such an embodiment, when a request for the IUI is received, the rendered IUI is accessed and provided (e.g., transmitted).

In an example embodiment, the IUI is stored as the data object encoding the IUI. Responsive to receiving a request, the IUI is rendered (in various instances based at least in part on information included in the request and/or associated with the requesting user computing entity 30). The rendered IUI is then provided (e.g., transmitted).

In various embodiments, the user computing entity 30 receives the rendered IUI (e.g., via network interface 320 and/or receiver 306). The user computing entity 30 processes the received IUI (e.g., via processing device 308), which causes the IUI to be displayed via a graphical user interface displayed via the display 316. In various embodiments, the graphical user interface is that of a browser (e.g., a web browser) operating at least in part on the user computing entity 30 and the IUI is a webpage. In various embodiments, the graphical user interface is that of an application and/or program operating at least in part on the user computing entity 30 and the IUI is a page of the application and/or program.

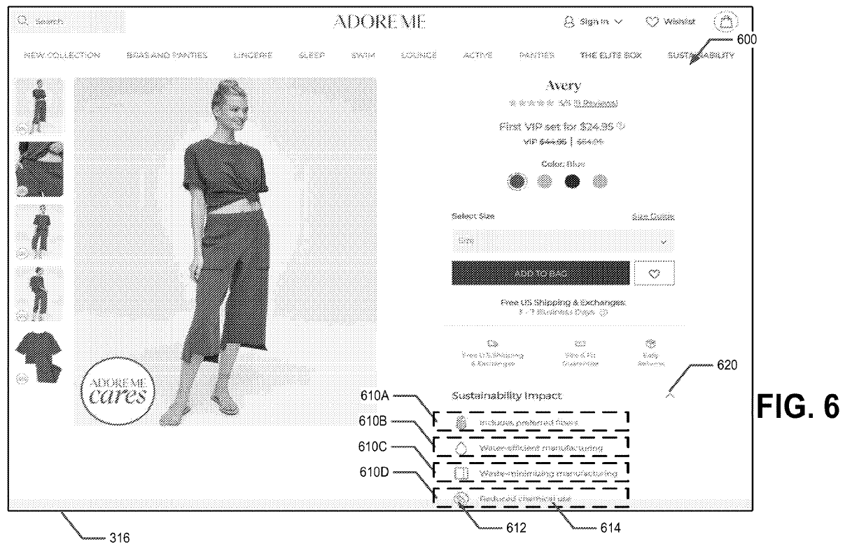

FIG. 6 illustrates a screen shot of a portion of an example IUI 600, according to an example embodiment. In the example embodiment, the item is an article of clothing and the IUI 600 is webpage of an online catalog. As should be understood, in various embodiments, the item may be one of various types of items and the IUI may be one of various types of webpages and/or application/program pages.

The IUI 600 includes respective graphical elements 610 (e.g., 610A, 610B, 610C, 610D). Each respective graphical element 610 includes a graphic 612 and text 614.

In the illustrated embodiment, the graphic of each respective graphical element 610 is a black (or other color) and white line drawing. For example, the graphic of each respective graphical element 610 is a unicolor graphic, in an example embodiment. This ensures that the graphic requires only a small amount of memory for storage and/or a small amount of bandwidth for transmitting (e.g., the size of the graphics of the respective graphical elements 610 do not amount to a significant amount of the bandwidth required for transmitting the IUI). In various embodiments, the graphic 612 of a respective graphical element 610 is indicative of the content of the text 614 of the respective graphical element 610. In an example embodiment, the graphic 612 indicates and/or provides a representation of the corresponding sustainability consideration category of the sustainability impact matrix.

In various embodiments, the text 614 of a respective graphical element 610 is a low-word count description and/or summary of the corresponding qualification criteria and/or portion of the item information that satisfied the corresponding qualification criteria. In various embodiments, the low-word count description and/or summary comprises no more than a threshold number of words. In various embodiments, the threshold number of words permitted in the text 614 (e.g., the low-word count description and/or summary of the portion of the item information that satisfied the corresponding qualification criteria) is language specific. In various embodiments, for English the threshold number of words permitted in the text 614 of a respective graphical element 610 is ten, eight, five, or three words. In an example embodiment, the number of words permitted in the text 614 is device specific such that the threshold number of words permitted is smaller for a device having a smaller screen (e.g., three to five words when the requesting user computing entity 30 is a handheld device such as a smartphone, tablet, PDA, and/or the like) compared to a device having a larger screen (e.g., eight to ten words when the requesting user computing entity 30 is not a handheld device (e.g., a laptop, desktop computer, and/or the like)).

In the embodiment corresponding to the example IUI 600, the sustainability impact matrix defines at least four sustainability consideration categories. For example, first graphical element 610A corresponds to the sustainability consideration category Fiber, second graphical element 610B corresponds to the sustainability consideration category Water, third graphical element 610C corresponds to the sustainability consideration category Waste, and fourth graphical element 610D corresponds to the sustainability consideration category Chemicals. Thus the IUI 600 includes at most one graphical element 610 corresponding to each sustainability consideration category defined by the sustainability impact matrix. Thus, the IUI 600 provides an easy to consume and/or digest summary of select portions of the sustainability information corresponding to the item. In various embodiments, the portions of the sustainability information corresponding to the item that are selected to have a summary thereof provided are dynamically selected and/or personalized for the user (e.g., user demographics, user preferences and/or interests as indicated by a user profile, user location, and/or the like). In various embodiments, the graphical elements 610 included in the IUI 600 are configured to provide a user with an easy to consume and/or digest summary of select portions of the sustainability information corresponding to the item that are configured for the size of the display 316 on which the user is viewing the IUI 600, for example, enabling and/or causing the user computing entity 30 functions in an improved and/or optimized manner.

In an example embodiment, the IUI 600 comprises an interactive toggle element 620. In an example embodiment, the IUI 600 is first displayed via the display 316 without displaying the graphical elements 610. A user may control a user input device (e.g., mouse) of the user computing entity 30 to interact with the interactive toggle element 620 and thereby cause the graphical elements 610 to be displayed via the IUI 600. For example, the graphical elements 610 are displayed responsive to user interaction with the interactive toggle element 620, in an example embodiment. This enables the user of the user computing entity 30 to access the information provided by the graphical elements 610 at will while also allowing the user to view a simplified IUI at will, which improves the user experience of consuming information via the IUI.

In the illustrated example, the IUI 600 further includes information about the item, color options, size options, price of the item, reviews of the item, interactive elements that may be used to add the item to an electronic shopping cart, and/or the like.

### Technical Advantages

As will be recognized by one of ordinary skill in the art, an ongoing challenge in interactive user interface design is to maximize the user experience by providing sought-after information in a consistent, logical, and low-effort fashion. Additional technical challenges for maximizing the user experience by providing sought-after information in a consistent, logical, and low-effort fashion exist for devices having smaller screens (e.g., handheld devices such as smartphones, tablets, personal digital assistants, and/or the like).

Various embodiments provide technical solutions to these challenges in the technical field of interactive user interface design. For example, in various embodiments, item information for a plurality of sustainability consideration categories is obtained for an item. The item information is then summarized and only select information is provided via the IUI. In particular, the information is organized and summarized based on a sustainability impact matrix which defines the plurality of sustainability consideration categories. Information is selected for display via the IUI based on whether respective qualification criteria are satisfied. Moreover, the information that is selected for display is represented in the IUI via one or more graphical elements that each provide respective information in an easy to digest, graphical and/or small word count format (e.g., ten/five words or less in an example embodiment). Thus, various embodiments enable an IUI to provide an improved user experience through the particular summarization, selection, and representation of information corresponding to an item as disclosed herein. The graphical element representation of the information corresponding to the item provides further technical advantages when considering IUIs configured for display by devices having smaller screens as the summarized and selected information is efficiently provided by the graphical element. Moreover, the improved user experience provided by the IUI improves user engagement with the sustainability information corresponding to the item and provides increased usability of the sustainability compared to the raw item information. Thus, various embodiments provide technical improvements.

### V. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for providing an interactive user interface corresponding to an item, the method comprising:
obtaining, by one or more processors, item information corresponding to an item;
processing, by the one or more processors, the item information based at least in part on a sustainability impact matrix defining a plurality of sustainability consideration categories and respective sub-categories of respective ones of the plurality of sustainability consideration categories, for each category of the plurality of sustainability consideration categories, whether the item satisfies one or more respective qualification criteria associated with the respective category;
for at least one of the one or more respective qualification criteria that the item is determined to satisfy, identifying, by the one or more processors, a respective graphical element from a plurality of graphical elements based at least in part on the at least one of the one or more respective qualification criteria that the item is determined to satisfy, wherein the respective graphical element provides a summarized representation of a portion of the item information that satisfies the at least one of the one or more respective qualification criteria that the item is determined to satisfy;
populating, by the one or more processors, at least one data field of a data object encoding an interactive user interface corresponding to the item with an identifier configured to identify the respective graphical element or locator indicating where in a memory accessible to the one or more processors the respective graphical element is stored;
causing, by the one or more processors, the data object encoding the interactive user interface corresponding to the item to be rendered such that the interactive user interface comprises the respective graphical element; and
causing, by the one or more processors, the interactive user interface to be displayed via a display of a user computing entity.

2. The method of claim 1, wherein, when the interactive user interface comprises two or more respective graphical elements, respective positioning in the interactive user interface of the two or more respective graphical elements is determined based on respective weights associated with the respective qualification criteria corresponding to the two or more respective graphical elements.

3. The method of claim 1, wherein the respective weights are dynamic weights that are determined based on at least one of (a) a class associated with the item, (b) a location of the user computing entity that is to display the interactive user interface, (c) a user profile corresponding to a user associated with the user computing entity, or (c) a device type associated with the user computing entity.

4. The method of claim 1, wherein each of the one or more respective qualification criteria and each of the plurality of graphical elements is associated with a respective category of the plurality of sustainability consideration categories, and the interactive user element comprises at most one respective graphical element for each of the plurality of sustainability consideration categories.

5. The method of claim 1, wherein processing the item information based at least in part on the sustainability impact matrix to determine whether the item satisfies the one or more respective qualification criteria associated with the respective category comprises determining a category score or a sub-category score for the respective category based on the item information and the sustainability impact matrix and determining whether the category score or sub-category score satisfies a respective qualification criteria of the one or more respective qualification criteria associated with the respective category.

6. The method of claim 1, wherein the item information comprises information regarding the manufacture of the item and the plurality of sustainability consideration categories comprises categories relating to different aspects of the manufacture of the item.

7. The method of claim 6, wherein the different aspects are different sustainability factors.

8. The method of claim 1, wherein the interactive user interface indicates how environmentally friendly the item is via inclusion of the respective graphical element.

9. The method of claim 1, wherein the item information is stored as part of an item profile corresponding to the item and is indexed by an item identifier configured to identify the item.

10. The method of claim 1, wherein the item information is obtained via at least one of (a) user input via a user input device, (b) extracting the item information from one or more manufacturing aspect databases based on manufacturing information or supply information corresponding to the item based at least in part on the sustainability impact matrix.

11. The method of claim 1, the respective graphical element is displayed via the display of the user computing entity responsive to user interaction with an interactive toggle element of the interactive user interface.

12. The method of claim 1, wherein the interactive user interface is (a) a webpage displayed via a browser operating on the user computing entity or (b) a page of an application operating on the user computing entity.

13. An apparatus comprising one or more processors and a memory storing computer-executable instructions, the computer-executable instructions configured to, when executed by the one or more processors, cause the apparatus to at least:
obtain item information corresponding to an item;
process the item information based at least in part on a sustainability impact matrix defining a plurality of sustainability consideration categories and respective sub-categories of respective ones of the plurality of sustainability consideration categories, for each category of the plurality of sustainability consideration categories, whether the item satisfies one or more respective qualification criteria associated with the respective category;
for at least one of the one or more respective qualification criteria that the item is determined to satisfy, identify a respective graphical element from a plurality of graphical elements based at least in part on the at least one of the one or more respective qualification criteria that the item is determined to satisfy, wherein the respective graphical element provides a summarized representation of a portion of the item information that satisfies the at least one of the one or more respective qualification criteria that the item is determined to satisfy;
populate at least one data field of a data object encoding an interactive user interface corresponding to the item with an identifier configured to identify the respective graphical element or locator indicating where in a memory accessible to the one or more processors the respective graphical element is stored;
cause the data object encoding the interactive user interface corresponding to the item to be rendered such that the interactive user interface comprises the respective graphical element; and
cause the interactive user interface to be displayed via a display of a user computing entity.

14. The apparatus of claim 13, wherein, when the interactive user interface comprises two or more respective graphical elements, respective positioning in the interactive user interface of the two or more respective graphical elements is determined based on respective weights associated with the respective qualification criteria corresponding to the two or more respective graphical elements.

15. The apparatus of claim 13, wherein the respective weights are dynamic weights that are determined based on at least one of (a) a class associated with the item, (b) a location of the user computing entity that is to display the interactive user interface, (c) a user profile corresponding to a user associated with the user computing entity, or (d) a device type associated with the user computing entity.

16. The apparatus of claim 13, wherein each of the one or more respective qualification criteria and each of the plurality of graphical elements is associated with a respective category of the plurality of sustainability consideration categories, and the interactive user element comprises at most one respective graphical element for each of the plurality of sustainability consideration categories.

17. The apparatus of claim 13, wherein processing the item information based at least in part on the sustainability impact matrix to determine whether the item satisfies the one or more respective qualification criteria associated with the respective category comprises determining a category score or a sub-category score for the respective category based on the item information and the sustainability impact matrix and determining whether the category score or sub-category score satisfies a respective qualification criteria of the one or more respective qualification criteria associated with the respective category.

18. The apparatus of claim 13, wherein the item information is obtained via at least one of (a) user input via a user input device, (b) extracting the item information from one or more manufacturing aspect databases based on manufacturing information or supply information corresponding to the item based at least in part on the sustainability impact matrix.

19. The apparatus of claim 13, the respective graphical element is displayed via the display of the user computing entity responsive to user interaction with an interactive toggle element of the interactive user interface.

20. The apparatus of claim 13, wherein the interactive user interface is (a) a webpage displayed via a browser operating on the user computing entity or (b) a page of an application operating on the user computing entity.
